(19) United States
(12) Patent Application Publication
(10) Pub. No.: US 2005/0177424 A1
(43) Pub. Date: Aug. 11, 2005

(54) System and method for efficiently effectuating gainshare collaboration between buyers, sellers and third party service providers in supply communities

(76) Inventor: Charles F. Irwin, Guilford, CT (US)

Correspondence Address: Charles Y. Lackey, PO Box 5871, Winston-Salem, NC, 27113-5871, US

(21) Appl. No.: 10/775,680

(22) Filed: Feb. 11, 2004

(51) Int. Cl. G06F 17/60

(52) U.S. Cl. 705/14

(57) ABSTRACT

The invention is a system and process for inducing collaboration among buyers, sellers and third party suppliers by having participants establish favorable financial consequences for one or more other participants who are motivated to achieve or exceed a minimum level of performance on one or more key performance indicators. It is particularly beneficial because it enables any participant in a supply community to cost-effectively collaborate in gainsharing efforts with many other participants contemporaneously. Contrary to the gainsharing practices in labor remuneration and one-on-one buyer/seller business arrangements, gainsharing in this development can be practiced by many participants (partners) with many other participants (other partners) in a most cost-effective manner. Individual contracts are not required since each sponsoring or participating partner has accepted the same policy and procedures agreement when becoming a member in the web-site application significantly reducing the effort required to initiate a program. Data collection, key performance indicator generation and reporting are all standardized. Credit/debit reconciliation is automated. The productivity gains enable the partners to initiate and execute incentive programs with many partners, not just the most significant. This novel capability provides the potential for entire markets to move toward the highest value aggregated state rather than toward a lower value state defined by the cumulative highest value states of sub-optimized buyer-seller dyads.

### BACKGROUND OF THE INVENTION

(1) Field of the Invention

The present invention relates to collaborative gainsharing incentive programs between supply community partners, including buyers, sellers and third party service providers and more particularly to a method and system for effectuating collaboration by enabling the establishment of favorable and unfavorable consequences that motivate participants to achieve or exceed a minimum required level of performance.

(2) Description of the Prior Art

Business Partners must collaborate to compete in today's marketplace, especially to drive growth by short-cycle innovation and to liberate the resources necessary to fund growth. Unfortunately, their attempts to accomplish the latter by collaborating to drive out non-value added costs are often frustrated by one or more factors, such as:

(a) Relationship: Buyer-seller relationships are fundamentally adversarial, by natural predisposition. Breaking through to a win-win partnership requires an unnatural level of trust, integrity, and cooperation, achieved only by a step of faith (by both parties) followed by shared values and consistent behavior, or a sufficiently long-term relationship for trust to develop. Both are rare indeed in today's marketplace.

(b) Performance Reporting: Often the buyer and seller do not have a single unified view of their mutual performance in the extended supply chain. For example, buyers measure the seller's performance versus the buyer's request (order), while sellers measure their own performance versus their commitment to the buyer (which may be different than the order). Frustration results when the partners, despite their best intentions, are unable to agree on the gaps that must be closed by a joint continuous improvement program because their metrics are not aligned.

(c) Product and Process Complexity: There exists a natural tension between the seller's need to standardize (to reduce complexity) and the buyer's need to differentiate (which increases complexity). At best, the seller is able to meet each buyer's diverse and conflicted needs within an acceptable financial or performance impact. At worst, the seller must make difficult prioritization decisions (choosing one buyer over another) without adequate financial rigor. The decision process becomes subjective, internal strife ensues, and the enterprise becomes increasingly inwardly focused.

(d) Economics: The value of an improvement opportunity is rarely naturally allocated to spontaneously and simultaneously drive the desired behavior by both buyer and seller. For example, often the incremental cost required to realize the improvement is borne by the seller, while the savings accrue to the buyer. If so, the seller will only invest if the buyer commits to an increased revenue stream (achieved, for example, by increasing the selling price, period, term or volume of the supply contract). Needless to say, the reverse situation, where the buyer invests and the seller realizes the savings, is even more problematic.

Being limited by these barriers, buyer and sellers typically resort to three common approaches for forcing or motivating their business partners to change, all of which have their limitations.

(a) Buyers simply institute new standards (specifications) for the product, process, or service performance, and rely on the competitive context to ensure that the seller(s) comply at an acceptable cost. This is most effective in an over-supplied market, but does not necessarily produce the highest value solution.

(b) Sellers, on the other hand, seek to incentize (hereinafter shortened to “incent” for ease of usage) the desired Buyer performance through terms of sale programs, which typically share logistics cost savings realized by the seller with the buyer. Unfortunately, enforcement is difficult, at best. Often the credit is allowed even though it has not been truly earned.

(c) There are instances where sellers and buyers do enter into strategic relationships to accelerate innovation and simplify the supply chain. Each solution is structured individually and typically governed by a negotiated contract. As a result, significant resource is required to scale this approach to extend it to the partner community at large, thereby limiting it to one-off arrangements.

Clearly, a more robust solution is required to address the needs of the business partners in the supply community. Such a solution will succeed only if it is:

(a) Trusted: The solution's process must be sensible and fair, and the rules must be pre-defined and enforced.

(b) Relevant: The key performance indicators and their targets must be explicit and objective, and based on the needs of the partner (customer) as defined by the partner (customer).

(c) Economic: The key performance indicators must be monetized (i.e., economic value associated with a change in level of the key performance indicator ) to enable economic-based decisions.

(d) Cheap and Easy: The solution's process must be simple and intuitive, extendable with little incremental cost or effort, and inexpensive relative to the expected benefits.

The domestic U.S. Transportation Marketplace is especially needful of such a solution. Revisions to the hours of service regulations that control driver work time became effective on Jan. 4, 2004. The key change from the prior regulations was that non-driving activities performed by drivers at the ship from/to location (such as waiting, loading, unloading, counting, sorting and segregating, etc) became on-duty activities, thereby accruing against the driver's 14 hour time limit. This will force carriers to increase the value that they associate these non-drive time activities, changing the economics of dwell time at ship locations. This market discontinuity presents a perfect opportunity for a solution that enables shippers, carriers, and customers (a.k.a. consignees) to collaborate to improve the operation of the extended supply chain so as to avoid these increased costs.

A solution is needed that can be applied to any buyer-seller relationship where the performance or behavior of one partner unfavorably impacts the cost or performance of another partner. In such a situation, the affected partner benefits if that partner successfully influences the affecting partner to change its behavior so as to eliminate the unfavorable impact on the affected partner. The most effective influencing strategy would seem to be to monetize the wasteful and undesired performance of the affecting partner by financially rewarding that partner, after the desired change is made, by sharing a portion of the economic value that the affected partner associates with the desired change in performance. It is to this incentive (a.k.a. gainsharing) concept that the present invention is directed by providing a system and method that can be efficiently and effectively applied in many-to-many supply communities.

### BRIEF SUMMARY OF INVENTION

The present invention is a method and apparatus for effectuating collaboration between one or many buyers and sellers, and their third-party service providers, (collectively called Partners) in a supply community. The present invention enables any Partner to establish financial consequences that motivate one or many selected supply chain Partners to achieve or exceed a minimum required level of performance on one or many performance indicators. The one or many indicators measure the aggregated performance for a set of events defined by a time or count period, wherein the performance indicator, its time or event count period, the financial consequence, and the minimum required level or performance are selected and/or specified by the establishing Partner (hereinafter collectively referred to as an “incentive program”). The establishing Partner must specify a time or event count duration period, during which period the establishing Partner can increase a favorable consequence or reduce the minimum required level of performance, and after which may discontinue the incentive program with different and, if desired, initiate a new incentive program with different (perhaps more stringent) parameters. In a preferred embodiment, the system of the present invention includes an internet-based web-site application by which establishing Partners (also referred to as “program sponsoring Partners”) can, for any group or groups of their supply chain Partners, create incentive programs by specifying the required program parameters, and thereafter change the parameters, as allowed, to maximize the performance or the economic gain realized by the program sponsoring Partners, wherein the web-site application automatically calculates the performance of each Partner on each performance indicator, determines the (aggregate) reward payable to the Partner, and automatically settles the credits and debits accrued by the program sponsoring Partner and each Partner, without necessitating the program sponsoring Partner to enter into a contractual agreement with any Partner. The method and system of the present invention have application for any buyer-seller relationship in any market.

Thus, there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth below, along with the various features of novelty which characterize the invention, are noted with particularity in the claims annexed to and forming a part of this disclosure. For a better understanding of the invention, its operating advantages and the specific results obtained by its use, reference should be made to the following detailed description taken in conjunction with the accompanying drawings wherein like characters of reference designate like parts throughout the several views.

The drawings are included to provide a further understanding of the invention and are incorporated herein and constitute a part of the specification. They illustrate embodiments of the invention and, together with their description, serve to explain the principles of the invention.

### BRIEF DESCRIPTION OF THE DRAWINGS

FIG. 1 is a block diagram illustrating the creation and modification of incentive programs wherein an establishing Partner must specify or select ( i) one or more invited Partners, (ii) one or more key performance indicators, (iii) the minimum required performance level, the consequence when the minimum required performance level of each performance indicator is met, and a measurement period for each performance indicator, and (iv) the program duration with starting and ending dates.

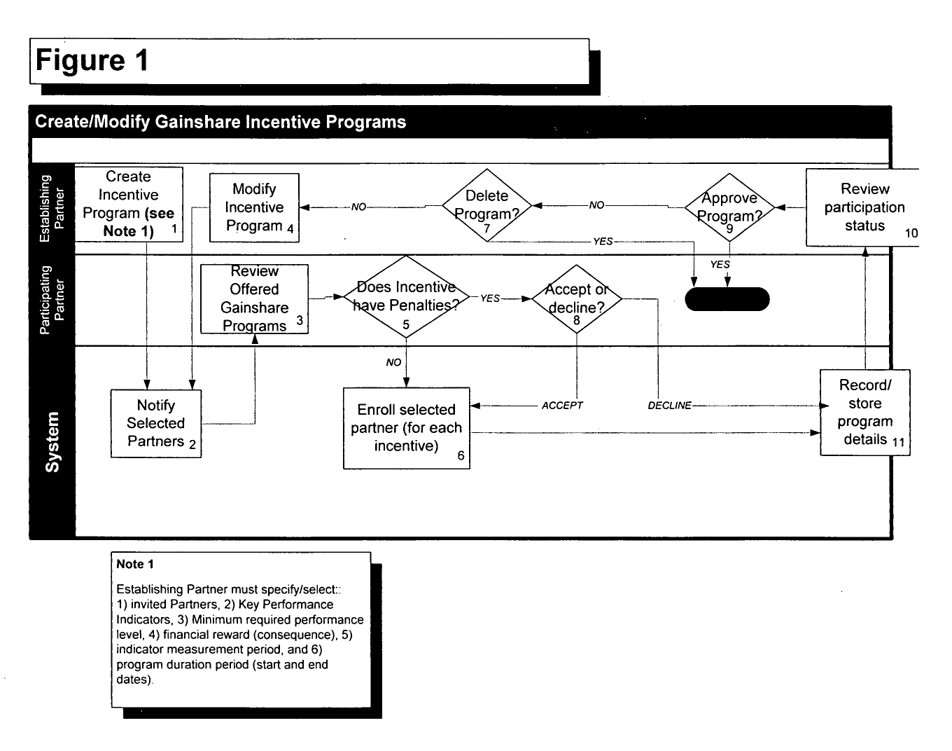

FIG. 2 is a block diagram illustrating the execution of the incentive program during which each program duration selected by an establishing partner may increase the reward or reduce the minimum required performance levels for a particular key performance indicator.

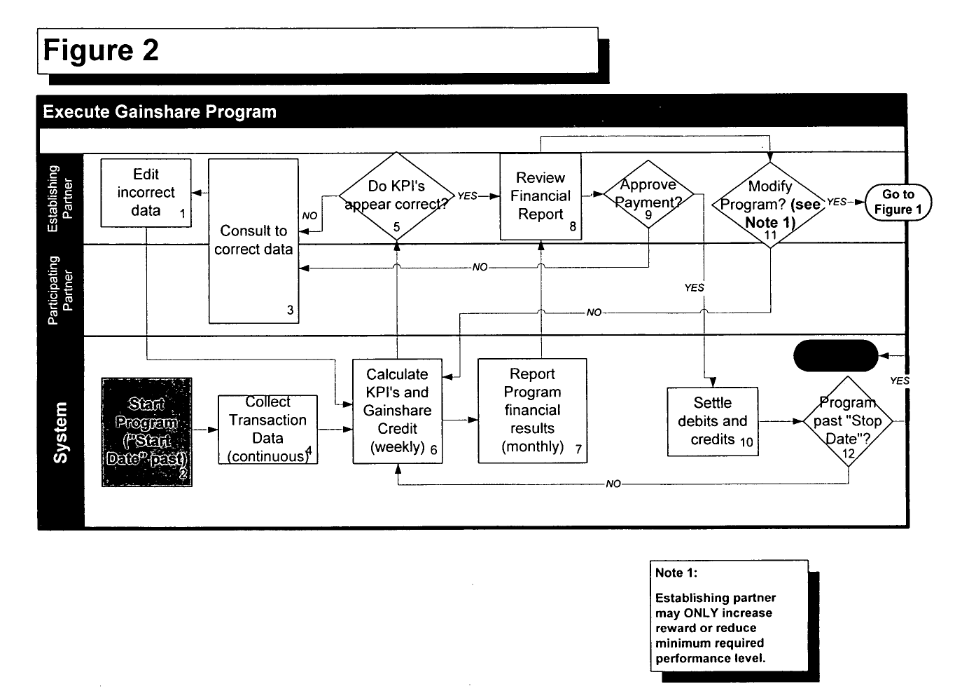

### DETAILED DESCRIPTION OF THE INVENTION

The incentive program of the present invention utilizes a concept that can be applied to any buyer-seller-third party provider relationship in any supply community where the performance of one Partner (unfavorably) impacts the cost or performance of another Partner. In such a situation, the affected Partner benefits if that Partner successfully influences the affecting Partner to change its performance so as to eliminate the unfavorable impact. The most effective influencing strategy is to financially reward the affecting partner after the change is made by sharing a percentage (up to, and optionally over, 100%) of the economic value that the affected Partner associates with the desired improvement in performance.

Having decided to so influence their Partners, the affected Partner creates the incentive program, and as a sponsor of the program, specifies the following parameters for the program: (a) the financial reward (consequence); (b) the key performance indicator and the minimum required performance level that must be exceeded to earn the reward; (c) the program duration and, (d) the Partners to be invited to participate in the program.

If an invited Partner accept the invitation to participate, and if and when the performance of the then participating Partner exceeds the minimum required level of performance, the program sponsoring Partner receives a debit and the participating Partner receives a credit in the amount of the reward. If the Partners are active in other programs, a net debit or credit is determined. The debits and credits are then settled, preferably by first invoicing the debits and then paying the credits after an established period of days after receipt of funds. Program sponsoring Partners are motivated to pay on time as their participating Partners will be less than pleased with slow credit payments.

A key feature of the incentive program is that the program sponsoring Partner controls the frequency by which the bar is raised by determining the program duration and the amount by which the minimum required performance level is increased in successive programs to ensure that the program sponsoring Partner (the affected party) does (eventually) receive the entire benefit. However, if the program sponsoring Partner establishes a short duration period, signaling that it intends or plans to raise the bar (the minimum required performance level) quickly, the invited Partners may choose not to participate, particularly if an investment is required to perform at or above the threshold level. Since each program is monetized (as determined by the program parameters) and the invited Partners are free to choose the incentive programs in which they participate, it is expected (all other things being equal) that each invited Partner will participate so as to maximize its economic gain. Program sponsoring Partners are free to adjust the parameters on their programs, prior to the program start date (if not satisfied with the acceptance of the invited Partners), or during the program duration (by reducing the target threshold or increasing the financial reward), or after the incentive program end date (whereupon a new incentive program with different parameters can be created).

The present invention is particularly beneficial in that it enables any Partner in any supply community to cost-effectively collaborate in gainsharing efforts with many of their Partners, contemporaneously. Gainsharing is a well-known practice, typically observed in (union) labor remuneration and in one-on-one (dyad) buyer-seller business arrangements. Such arrangements are typically governed by a negotiated contract, and require significant effort to develop, implement, and maintain. As such, current gainsharing practice and techniques are only used in the most significant of business relationships; they do not scale well, at all. The present invention resolves this limitation. Gainsharing can now be practiced by many partners with many other partners (“many-to-many”) in a most cost-effective manner. Individual contracts are not required, as each program sponsoring or participating Partner has accepted the same policy and procedures agreement when becoming a member Partner in the web-site application (see below), dramatically reducing the effort required to initiate a program. Similarly, data collection and key performance generation and reporting is standardized and automated within the web-site application, again reducing effort required. Even the credit/debit reconciliation is automated. The realized productivity gains enable the Partners to initiate and execute incentive programs with many Partners, not just the most significant. This novel capability affords the potential for whole markets to evolve towards the highest value aggregated state, rather than a lower value state defined by the cumulative highest value states of sub-optimized buyer-seller dyads.

In addition, the present invention resolves an especially awkward type of collaboration, namely intra-enterprise collaboration between two (or more) business units within a single business entity. It is well known that it can be difficult for divisions within a single corporate entity, where each division has its own profit accountability to collaborate so as to optimize the whole, simply because (typically) one division must incur a cost for the other for the other division to realize a savings. The division that incurs the net cost usually refuses to participate, unless the higher aggregating entity grants it special relief on their profit goals (in essence sharing the gain between the two divisions). The present invention resolves this tension. Now two divisions have the means to gainshare without involving the common boss. Both divisions can now win against their own profit goals, being confident that neither can take advantage of the other because the process is enforced by the incentive program business process on the web-site application.

In the transportation marketplace mentioned earlier, all participating Partners might derive benefit with no initial investment and minimal (if any) ongoing operational costs. The following chart sets forth the benefits that might be sought and an approach to achieving those benefits.

| | |
|---|---|
| Benefit | Approach |

Carriers

| Reduce/Eliminate | Reduce/eliminate driver assists by using the Incentive |
|---|---|
| Non-Value | Program to incent Locations to convert to Location |
| Added Costs | (Un) Load and Count. This will increase driver |
| | satisfaction and reduce driver turnover and driver |
| | retention costs. |
| Increase Return | Improve asset utilization (driver and equipment) by |
| on Assets | Sponsoring an Incentive Program to reduce dwell |
| | times (power and drop trailers) and shipment volatility, |
| | and increase shipment volume and planning lead times. |
| | Incent Shippers and Consignees to treat Carriers' |
| | assets (equipment and drivers) as their own using the |
| | Incentive Program to reduce power dwell times, |
| | increase trailer pool turns, and increase appointment |
| | compliance. |
| | Earn premium pricing by exceeding key performance |
| | indicator thresholds on Incentive Programs sponsored |
| | by Shippers or Customer (Consignees). |
| Increase | Improve Load Acceptance and On-Time by using the |
| Customer and | Incentive Program to increase lead time (Advance |
| Shipper | Load Planning, Pre-appointing) and reduce shipment |
| Satisfaction | volatility. |
| Benefit | Approach |

Shipper

| Customer | Deliver improved service to Customer by rewarding |
|---|---|
| Satisfaction | Carriers for improved On-Time with an Incentive |
| (On-time at | Program. |
| Location) | |
| Reduce/Avoid | Reduce earned accessorials by improving Ship |
| Costs | Location performance (especially dwell time and |
| | driver accessorials) using the Incentive Program. |
| Benefits | Approach |

Customer (Consignee)

| | |
|---|---|
| Make Money | Earn financial rewards by exceeding key performance |
| | indicator thresholds on Incentive Programs sponsored |
| | by Shippers or Carriers (power dwell time, pre- |
| | appointing, appt making compliance, providing |
| | accessorial information) |

The gainshare incentive program of the present invention can be incorporated in an internet web-site application which will enable business Partners in the truckload transportation marketplace (shippers, consignees and carriers) collaboratively to: (a) make and confirm pick-up and delivery appointments for truckload shipments, (b) record and share key transactional data, including accessorials incurred and proof-of-delivery documents, (c) measure and improve performance on key service and cost performance indicators, and (d) create and manage incentive programs that reward business partners for meeting threshold targets on the key performance indicators.

Such an internet web-site application is preferably modular in design with each module comprised of a narrow set of related capabilities and independent of the other modules (sharing only a common administration module and an underlying data base). This modular design reduces complexity, simplifies development and maintenance, and ensures reliability.

The modular design also helps ensure that the application, and its capabilities are intuitive and easy to use, so as to encourage adoption and consistent use by all individuals. Users will also be provided data entry options—a template (enter data into fields), manual Excel file uploads (or paste and copy), and an automated transfer server-to-server—to ease integration with current systems, regardless of business practice or process.

The structure for the modules is as follows:

1. Customer Care Module: This module welcomes visitors and invited guests to the web-site, communicates the vision and program, and then provides the information that the prospective member will want and need to make their decision to join (such as site tours, sample program and reports, press releases and articles, and customer testimonials). After completing the registration process and selecting the desired services, the member is then cared for with information (news letters, bulletin board and market updates), communication tools (buttons to e-mail the administrator, submit improvement ideas or touch a partner), and training tools (frequently asked questions, learning tutorials, and Help!). Partner administrators are also able to manage their account and archive data.

2. Master Data Entry and Management Module: Each member partner must enter and maintain its administrative data. First, the Partner designates an administrator, who then configures and assigns roles to users at that Partner. The administrator then creates a Partner list naming those Partners with whom they wish to collaborate. Each shipper and customer (consignee) must complete the ship location profile for every ship location. This profile records the information required by shippers and carriers to flawlessly plan and execute a shipment. The information is easily accessed and searched, and is maintained by the user responsible for that location. The location user configures the appointment schedule for that location in the appointment engine (for inbound and outbound shipments, as relevant). This schedule can be customized or changed to meet the needs of that location. Carriers complete a request for information survey that documents their capabilities. This information will be used by shippers to identify the carriers with the potential to offer the highest value against the shipper's needs.

3. Enter and Maintain Transactions Appointments Module: This module is the data warehouse where the data that drives the performance and incentive modules is entered and managed. Here, carriers request pick-up and deliver appointments by using the appointment engine and the location then confirms the appointment. Actuals for each shipment (against the planned appointments) are entered, by both the carrier and the location to ensure accuracy. Using an accessorial validation tool, the carrier and location independently indicate which accessorials the carrier provided while at the location. The shipper can then access or download this accessorial history to investigate discrepancies and to approve accessorials invoiced by the carrier. The carrier can scan and post proof of delivery documents for later use by the shipper to resolved deduction claims made by the customer.

4. Performance Module: This module is a data analysis engine that generates score card reports of the performance of each participating Partner as compared to the minimum required performance level for each key performance indicator. Users cab also drill down through the data to determine the root cause of any key performance indicator deviations against the required performance level. Examples of key performance indicators are: (a) on-time by location (versus appointment), (b) power dwell time by ship location and, (c) trailer dwell times (turns) by drop location.

5. Incentive Program Creation and Management Module: In this module, member Partners can create and manage their own incentive program(s). When they do so, they become a program sponsoring Partner and commit to rewarding any participating Partner for performance that exceeds the minimum required performance level specified by the sponsoring Partner in their program(s). For example, a supplier (shipper) that wishes to reduce power dwell time at a customer's receiving location might offer that customer a reward equal to half of the carrier detention accessorial savings if that location succeeds in reducing the actual dwell time. When the improvement is realized, the payment would be issued to the customer.

6. Account Management Module: In this module, the monthly financial statements for each partner is generated and posted. Receivables are invoiced and payments are issued for earned incentives. The partner administrator can review the account and approve each credit or debit to the account.

While the example given relates to the transportation industry, the concept of the described incentive program can be applied to any buyer-seller relationship, with or without supporting third-parties, in any supply community where the performance of a Partner (unfavorably) impacts the costs or performance of another Partner which in such a situation the affected partner benefits if it successfully influences the affecting Partner to change its performance so as to eliminate the unfavorable impact.

From the proceeding description, it can be seen that an incentive program has been provided that will meet all of the advantages of prior art programs and offer additional advantages not heretofore achievable. With respect to the foregoing invention, the optimum dimensional relationship to the parts of the invention including variations in format, material, shape, form, function, and manner of operation, use and assembly are deemed readily apparent to those skilled in the art, and all equivalent relationships suggested in the drawings and described in the specification are intended to be encompassed herein.

The foregoing is considered as illustrative only of the principles of the invention. Numerous modifications and changes will readily occur to those skilled in the art, and it is not desired to limit the invention to the exact operation shown and described. All suitable modifications and equivalents that fall within the scope of the appended claims are deemed within the present inventive concept.

1. In a system for effectuating collaboration between one or many buyers and sellers, and their third-party service providers, (collectively called “partners”) in a supply community which enables an establishing partner to establish consequences that motivate one or more other partners to achieve or exceed a minimum required level of performance on at least one performance indicator that measures aggregate performance for a set of events defined by a time or count period wherein the other partners, the performance indicators, the minimum level of performance required for each performance indicator, and the consequence for each performance indicator are selected and specified by the establishing partner all of which define an incentive program, a method including the steps of: selecting at least one other partner; selecting at least one performance indicator for each selected partner and specifying the minimum level of performance and the consequence for the at least one selected indicator; collecting and storing data necessary to calculate the performance of the at least one selected partner on the at least one selected performance indicator; analyzing the collected and stored data to generate an aggregated measure of performance for the time or event count period; and determining the credit or debit due to the at least one selected and participating partner for the time or event count period.

2. The method as claimed in claim 1 wherein the at least one selected partner is from a group of one or more partners where the group is defined by a common attribute that does not include the establishing partner.

3. The method as claimed in claim 1 wherein the at least one selected partner is from any group of at least one other partner.

4. The method as claimed in claim 1 wherein the establishing partner selects a group of at least one other partners and all partners in the selected group of partners share a common attribute.

5. The method as claimed in claim 1 wherein the establishing partner selects at least one other partner from more than one group of partners, each group having at least one other partner.

6. The method as claimed in claim 1 wherein the consequence for a selected incentive is a financial reward favorable to the at least one selected partner.

7. The method as claimed in claim 1 wherein the consequence for a selected incentive is a financial reward favorable and a financial penalty unfavorable to the at least one selected partner when the minimum required level of performance is not achieved.

8. The method is claimed in claim 6 or 7 wherein the consequence for a selected incentive is a financial reward that is less than or more than the net cost savings realized by the establishing partner for each unit increment improvement in performance when the at least one participating partner achieves and exceeds the minimum required level of performance on the at least one performance indicator.

9. The method as claimed in claims 2, 3, 4 or 5 wherein the least one selected partner may elect to participate or not to participate in any incentive and with any partner.

10. The method as claimed in claims 2, 3, 4 or 5 wherein the consequence for a selected incentive program is a financial reward favorable to the at least one selected partner and a financial penalty unfavorable to the at least one selected partner when the minimum required level of performance is not achieved and the at least one selected partner may elect to or not to participate in the selected incentive program.

11. The method as claimed in claims 2, 3, 4, or 5 wherein the consequence for a selected incentive program is a financial reward favorable to th at least one favorable selected partner and a financial penalty unfavorable to the at least one selected partner when the minimum required level is not achieved and the at least one selected partner may elect to participate or not to participate in the selected incentive program.

12. The method as claimed in claim 1 wherein the establishing partner can specify the time or count measurement period of the selected performance indicators and designate the minimum required level of performance and the consequence for each selected performance indicator the at least one selected partner.

13. The method as claimed in claim 12 wherein the establishing partner can specify the time or count incentive program duration period for each incentive incentive program for at least one more selected partner.

14. The method as claimed in claim 13 wherein the establishing partner can specify the minimum level of performance for a selected performance indicator with any partner.

15. The method as claimed in claim 1 wherein the establishing partner can specify the minimum required level of performance for at least one selected performance indicator with at least one selected partner.

16. The method as claimed in claims 1, 6 and 15 wherein the establishing partner may increase any favorable reward or reduce the minimum required level of performance for a selected incentive program anytime during the time or count incentive program duration period for that incentive.

17. The method as claimed in claim 16 wherein the establishing partner may lower the time or count measurement period at anytime.

18. The method as claimed in claim 16 wherein the establishing partner may change the time or count measurement period at anytime provided that the time or count measurement is not longer than the time of couny incentive program duration period.

19. The method as claimed in claim 14 wherein the establishing partner may discontinue a selected and specified incentive at any time after completion of the time or count incentive program duration period.

20. The method as claimed in claim 1 further comprising the steps of: collecting and storing data necessary to calculate the selected performance indicators wherein the data quantitatively describes the product or service provided and the means of providing the product or service using selected attributes.

21. A system for effectuating collaboration between one or many buyers and sellers, and their third party service providers (“partners”) in a supply community which enables an establishing partner to establish consequences that motivate one or more to achieve or exceed a minimum required level of performance on at least one performance indicator that measures aggregate performance for a set of events defined by a time or count period wherein the other partners, the performance indicators, the minimum level of performance required for each performance indicator, and the consequence for each performance indicator are selected and specified by the establishing partner, all of which define an incentive program, the system comprising: means for an establishing partner to select at least one other partner; means for the establishing party to select at least one performance indicator for each selected partner and to specify the minimum required level of performance and the consequence for the at least one selected indicator; means for collecting and storing data necessary to calculate the performance of the at least one partner on the at least one selected performance indicator; means for analyzing the collected and stored data to generate an aggregated measure of performance for the time or event count period; and means for determining the credit or debit due to the at least one selected and participating partner for the time or event count period.

22. The system as claimed in claim 21 wherein the at least one selected partner is selected from a group of one or more partners where the group is defined by a common attribute and does not include the group of the establishing partner.

23. The system as claimed in claim 22 wherein the at least one selected partner is from any group of at least one other partner.

24. The system as claimed in claim 22 wherein the establishing partner selects a group of at least one other partner where the at least one other partner in the selected group of partners shares a common attribute.

25. The system as claimed in claim 22 wherein the establishing partner selects at least one other partner from more than one group of partners each group having at least one other partner.

26. The system as claimed in claim 22 wherein the consequence for a particular incentive is a financial reward favorable to the at least one selected partner.

27. The system as claimed in claim 22 wherein the consequence for a selected incentive is a financial reward favorable to the at least one selected partner and a financial penalty unfavorable to the at least one selected partner when the minimum required level of performance is not achieved.

28. The system as claimed in claims 26 or 27 wherein the consequence for a selected incentive is a financial reward that is less than or more than the net cost savings realized by the establishing partner for each unit improvement in performance when the at least one participating partner achieves and exceeds the minimum required level of performance on the at least one performance indicator.

29. The system as claimed in claims 23, 24, 25 or 26 wherein the at least one selected partner may elect to participate or not participate in any incentive and with any partner.

30. The system as claimed in claims 23, 24, 25 or 26 wherein the consequence for a selected incentive program is a financial reward favorable to the at least one selected partner and the at least one selected partner the at least one selected partner must participate in the selected incentive program.

31. The system as claimed in claims 23, 24, 25 or 26 wherein the consequence for a selected incentive program is a financial reward favorable to the at least one selected partner and a financial penalty unfavorable to the at least one selected partner when the minimum required level of performance is not achieved and the selected partners may elect to participate or not to participate in the selected incentive program.

32. The system as claimed in claim 22 wherein the establishing partner can establish the time or count measurement period of the selected performance indicators and designate the minimum required level of performance and the consequence for each selected performance indictor for at least one selected partner.

33. The system as claimed in claim 32 wherein the establishing partner can specify the time or count incentive program duration period for each incentive for at least one selected partner.

34. The system as claimed in claim 33 wherein the establishing partner must specify a time or count incentive program duration period that is greater than the specified time or count measurement period for the at least one selected performance indicator.

35. The system as claimed in claim 22 wherein the establishing partner can specify the minimum required level of performance for a selected performance indicator with at least one selected partner.

36. The system as claimed in claims 22, 25 or 35 wherein the establishing partner may increase any favorable reward or reduce the minimum required level of performance for a specified incentive program anytime during the time or count incentive program duration for the selected incentive program.

37. The system as claimed in claim 36 wherein the establishing partner may lower the time or count measurement period at anytime.

38. The system as claimed in claim 37 wherein the establishing partner may change the time or count measurement period at anytime provided the time or count measurement is not longer than the time or count incentive program duration period.

39. The system as claimed in claim 35 wherein the establishing partner may discontinue a selected and specified incentive program at anytime after completion of the time or count incentive program duration period.

40. The system as claimed in claim 22 wherein the system is modular in design and the modules include a customer care module, a data entry and management module, an incentive program creation and management module and an account management module.

41. The system as claimed in claim 40 wherein the customer care module provides information for prospective partners, enrolls joining partners, and provides new partners with information, communication tools and training tools; the master data entry and management module maintains the required and necessary master data about each business and locations; the transaction module enters and manages the data that drives the performance and incentive modules; the performance module evaluates the performance of each participating partner against the key performance indicators; the incentive program creation and management module provides the partners with means to create and manage their own incentive programs; and the account management module provides a monthly financial report and invoice for each partner.

42. The system as claimed in claim 22 wherein the establishing partner selects a group of partners and all partners in the selected group of partners share a common attribute, the establishing partner selects partners from more than one group of partners, the consequence for a selected performance indicator may be more than or less than the net cost savings realized by the establishing partner for each unit improvement in the at least one performance indicator, the at least one selected partner must participate in all incentive programs with all establishing partners, the at least one selected partners may elect to participate or not participate in any incentive program with any establishing partner, the establishing partner can specify the time and count measurement duration for each incentive for each other partner, the establishing partner can specify the time or count program duration for each incentive for at least one selected partner, the establishing partner can specify the minimum required level of performance for a selected performance indicator with at least one selected partner, the establishing partner may change the time or count measurement at anytime provided that the time or count measurement period is not longer than the time or count incentive program duration period, and the establishing partner may discontinue an incentive program at anytime after the completion of the time or count duration period for that incentive program.

43. The method as claimed in claim 1 wherein the establishing partner and the at least one selected partner may be in the same corporate entity.

44. The method as claimed in claim 20 wherein the establishing partner and the at least one selected partner may be in the same corporate entity.

45. The system as claimed in claim 21 wherein the establishing partner and the at least one selected partner may be in the same corporate entity.

46. The system as claimed in claim 40 wherein the establishing partner and the at least one selected partner may be in the same corporate entity.

47. The method as claimed in claim 1 wherein the establishing partner selects a group of partners and all partners in the selected group of partners share a common attribute, the establishing partner selects partners from more than one group of partners, the consequence for a selected performance indicator may be more than or less than the cost savings realized by the establishing partner for each unit improvement in the at least one performance indicator, the at least one selected partner may elect to participate or not to participate in any incentive program and with any establishing partner, the establishing partner can specify the time or count program duration for each incentive for at least one selected partner, the establishing partner can specify the minimum required level of performance for a selected performance indicator with at least one selected partner, the establishing partner may change the time or count measurement period at anytime provided the time or count measurement period is not longer than the time or count incentive program duration period, and the establishing partner may discontinue an incentive program at anytime after the completion of the time or count duration period for the selected incentive program.
